(19) United States
(12) Patent Application Publication
(10) Pub. No.: US 2026/0260240 A1
(43) Pub. Date: Sep. 3, 2026

(54) Decentralized Commerce Through Embedded Rendering Data in Smart Contracts

(71) Applicant: Credenza Inc., Walnut Creek, CA (US)

(72) Inventor: Sanzib Khaund, Walnut Creek, CA (US)

(21) Appl. No.: 18/872,803

(22) PCT Filed: May 19, 2023
(86) PCT No.: PCT/US2023/023008

§ 371 Date: Dec. 7, 2024

Related U.S. Application Data
(60) Provisional application No. 63/354,685, filed on Jun. 23, 2022.

(51) Int. Cl. G06Q 20/40; G06Q 20/06; G06Q 20/36; G06Q 20/38; H04L 9/08; H04L 9/32

(52) U.S. Cl. CPC G06Q 20/4014; G06Q 20/065; G06Q 20/36; G06Q 20/3823; H04L 9/0825; H04L 9/3247; H04L 2209/56

(57) ABSTRACT

A system and method are disclosed for rendering consistent user interfaces stored in a blockchain smart contract. One asset may be sold on multiple websites using the same user interface rendered using metadata stored on a smart contract. A web application queries the smart contract for the rendering metadata. The web application generates a web element using metadata received from querying the smart contract. The web application renders the creator interface for display using the generated web element. For example, while an athlete may user a smart contract-rendered user interface to enable a consumer to purchase an NFT directly from their website, the athlete can also enable the same, smart contract-rendered interface to be available to consumers from other websites (e.g., websites for a sports organization, a sportswear company, etc.).

### CROSS REFERENCE TO RELATED APPLICATION

This application claims priority under 35 U.S.C. § 119 (e) to U.S. Provisional Patent Application Ser. No. 63/354,685, “Decentralized Commerce Through Embedded Rendering Data in Smart Contracts,” filed Jun. 23, 2022. The subject matter of all of the foregoing is incorporated herein by reference in its entirety.

### TECHNICAL FIELD

The disclosure generally relates to distributed ledgers and, more specifically, generation of user interfaces using a blockchain.

### BACKGROUND

Blockchains have been used for the purchase of digital assets. There is a simple workflow to authenticate, authorize purchase, and accept receipt of a digital asset purchased using a blockchain wallet. This workflow is simpler than the workflow of traditional online purchases, which requires additional operations such as credit card information input with risk of theft. However, the access of digital assets for purchase using blockchains are still limited by traditional e-commerce means of a centralized storefront. Traditional, centralized, third-party retail platforms collect data about an asset's transaction and requires creators to conform to the formatting template of the platforms' designs. The collection of data and the communication of the third-party retail website formatting consumes network bandwidth (e.g., Internet bandwidth with which the consumer's device is using to communicate). The reliance on a third-party retail platform is a risk to the fulfillment of the transaction when the third-party is unavailable (e.g., the server is compromised). Furthermore, the involvement of a centralized platform prevents a fully decentralized purchase cycle for the asset as intended by the implementation of blockchains.

### SUMMARY

A system and method are disclosed for rendering user interfaces using a blockchain. A creator may store metadata at a smart contract on the blockchain, where the metadata includes information for rendering a web interface for offering an asset for sale. A web application queries the smart contract for the metadata after a consumer visits a particular webpage of the creator, where instructions have been loaded at the webpage for rendering the interface using the smart contract. The interface is loaded at the creator's website rather than redirecting the consumer to a third-party retail platform to purchase the asset. By storing metadata to render the interface at the smart contract, the web application conserves network bandwidth that would have been used to render web elements of the third-party retail platform's interface that are also transmitted with the web elements sufficient for facilitating asset transaction. The web application also conserves network bandwidth occupied by the third-party retail platform for collecting information about transactions (e.g., for targeted advertising). Furthermore, by removing the dependence on a third-party retail platform for providing the interface, the web application eliminates risks associated with unavailable third-party retail platform services and preserves a fully decentralized transaction cycle using the blockchain.

Furthermore, rendering user interfaces using a smart contract on a blockchain enables a consistent user interface formatting across various websites (e.g., a retail website, a blog, Internet forums, etc.). One asset may be sold on multiple websites using the same user interface rendered using metadata stored on the smart contract. For example, an athlete is offering a non-fungible token (NFT) for sale. While the athlete may user a smart contract-rendered user interface to enable a consumer to purchase the NFT directly from their website, the athlete can also enable the same, smart contract-rendered interface to be available to consumers from the website of an organization representing their sport, the website of a sportswear company with which the athlete has an ambassadorship deal, the website of their sports team, and any other website that is authorized to execute instructions to generate the smart contract-rendered interface. Thus, a creator can provide a consistent user interface to their consumers across multiple websites. Additionally, the creator and various websites authorized by the creator can avoid involving a third-party retail platform to offer the asset to consumers.

In one embodiment, a web application accesses webpage instructions for generating a creator interface associated with a decentralized creator (e.g., a creator offering their assets over a blockchain). An asset of the decentralized creator is offered using this creator interface. In response to determining that a user has requested to use the creator interface, the web application may query a smart contract for metadata associated with the asset. The user of the web application requesting to purchase an asset may be referred to as a “consumer” and a user of the web application offering the asset for purchase may be referred to as a “creator.” The web application queries the smart contract in accordance with webpage instructions for generating the creator interface. The web application then generates a web element using the metadata received from the smart contract. The web application renders for display at a device of the consumer the creator interface using the generated web element.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a transaction environment in which the techniques described may be practiced, according to one embodiment.

FIG. 2 depicts a block diagram of a process for rendering a webpage interface using a smart contract, according to one embodiment.

FIG. 3 illustrates a conceptual illustration of smart contract-enabled interface generation, according to one embodiment.

FIGS. 4-5 form an interaction diagram showing various interactions between entities for using a smart contract to render an interface, according to one embodiment.

### DETAILED DESCRIPTION

The Figures and the following description describe certain embodiments by way of illustration only. One skilled in the art will readily recognize from the following description that alternative embodiments of the structures and methods may be employed without departing from the principles described. Wherever practicable, similar or like reference numerals identify similar or identical structural elements or identify similar or like functionality.

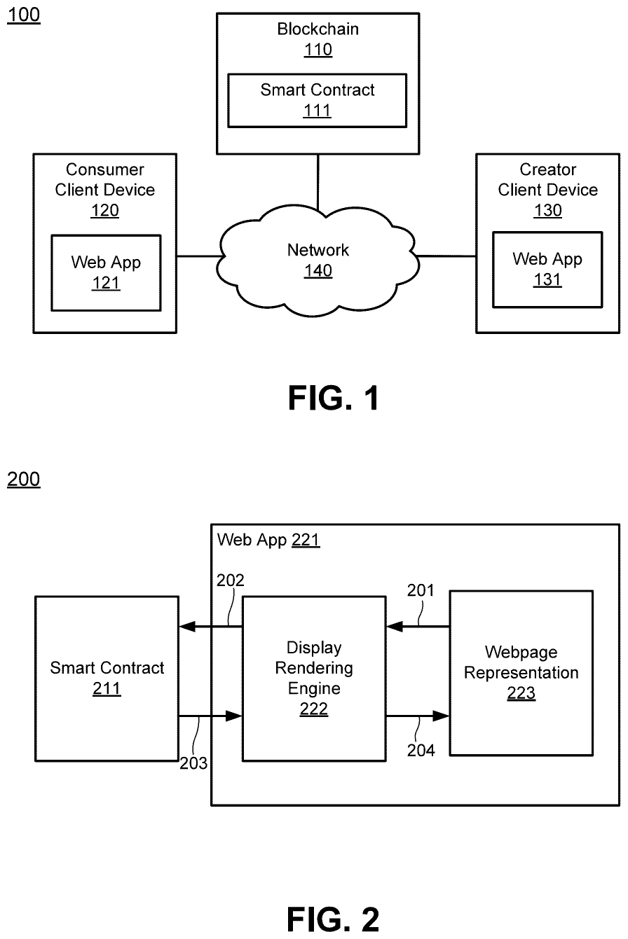

FIG. 1 illustrates transaction environment 100 in which the techniques described may be practiced, according to one embodiment. Transaction environment 100 includes blockchain 110, smart contract 111, customer client device 120, creator client device 130, and network 140. The network 140 may be the Internet. In alternative configurations, different or additional components may be included in transaction environment 100. For example, customer client device 120 may communicate with a cryptographic key pair creation service to receive a private key for verifying the customer's identity (e.g., to smart contract 111).

Blockchain 110 is a decentralized governance mechanism for processing asset transactions and storing smart contracts (e.g., smart contract 111). Blockchain 110 is a distributed ledger that can maintain persistent and reliable records of asset transactions. Blockchain 110 may also store account balances by maintaining a chain of transactions for each account. The term blockchain is used herein for convenience but one of skill in the art will understand that other forms of distributed ledger may be used. The blockchain may be used to process and maintain a record of transactions (e.g., financial transactions) between users.

Smart contract 111 enables access to metadata for generating an interface for purchasing an asset. Smart contract 111 may store an asset's metadata or access a library of metadata that is stored on blockchain 110. Smart contract 111 may store an identifier of the author of the metadata. Smart contract 111 may additionally enable one or more of consumer identity authentication, creator identity authentication, or cryptocurrency transactions. Smart contract 111 may include executable instructions (e.g., software functions) stored on a decentralized system (e.g., blockchain 110). Smart contract 111 may function according to the ERC-721 standard. Smart contract 111 may have a multiple inheritance structure, importing the implementation of each inherited contract's functions and variables. Smart contract 111 may receive an identifier of a creator asset and return metadata for rendering an interface for purchasing the asset. The metadata may contain data for web application 121 to construct a user interface for the consumer to purchase the asset. Examples of metadata that can be stored include asset storage details (e.g., a web address of a picture of an asset), price, description, or any suitable information related to the asset. In some embodiments, metadata may include credential or access privilege information associated with the asset. Smart contract 111 may access a library of metadata for assets, where the metadata may be retrievable using the asset identifier (e.g., indexed by an identifier of the asset).

One example of instructions included within smart contract 111 is shown in Table 1 below. Although the example code in Table 1 is expressed in Solidity, smart contract 111 may be implemented in any suitable object-oriented programming language for implementing smart contracts (e.g., Rust or Java). The “Embed Module” contract enables a contract having metadata for rendering an asset embedded within another contract for fulfilling a cryptocurrency transaction; thus, the functionalities can be combined via inheritance within a single contract (e.g., smart contract 111).

TABLE 1
Example Implementation for Smart Contract

```
contract EmbedModule {
  string renderString;
  address author;
  modifier validAuthor( ) {
        require(author == msg.sender, ″Only author can modify this
        data.″);
        _;
    }
  constructor( ) {
      author = msg.sender;
      renderString=”<DEFAULT VALUE>”;
  }
  function getRenderMetadata ( ) public view returns (string memory
  txt) {
      return renderString;
  }
  function setRenderMetadata (string memory newData) public
  validAuthor {
      renderString =newData;
  }
}
```

In the example shown in Table 1, smart contract 111 can set and generate data required to render an offer for an asset on a host site because “Embed Module” supports the attributes and method signatures shown. Smart contract 111 stores two attributes: an address that identifies the “author” of the metadata and the actual metadata renderString. The constructor is called when smart contract 111 is instantiated and provides a default metadata value as well as designating the smart contract's creator as the author of the metadata (e.g., the creator is identified through “msg.sender,” the address of the creator calling the smart contract during instantiation). By storing the creator's address into an author variable, smart contract 111 can implement editing permissions specifying that only the creator can modify the metadata. This is exemplified in the modifier validAuthor, which is appended to the “setRenderMetadata” method. As shown in Table 1, the “getRenderMetadata” method is not access-restricted; however, smart contract 111 may implement similar access restrictions to that of “setRenderMetadata” or implement identity authentication (e.g., using cryptographic key pairs) to limit access to verified authors.

Smart contract 111 may be implemented to minimize processing resources expended by computing nodes hosting blockchain 110. For example, because setRenderMetadata does not modify blockchain 110, its execution is faster than methods that do modify blockchain 110. Furthermore, smart contract 111 may store encrypted data (e.g., encrypted renderString value) to increase security. Web application 131 may encrypt the data at creator client device 130 to reduce processing resources expended by the computing nodes hosting blockchain 110. When the metadata is encrypted, web application 121 may decrypt the metadata after accessing the appropriate cryptographic key(s).

Consumer client device 120 and creator client device 130 are computing devices capable of receiving user input as well as transmitting and/or receiving data via network 140. Client devices 120 and 130 may be devices having computer functionality, such as a smartphone, tablet, personal computer, personal digital assistant (PDA), laptop, mobile telephone, or another suitable device. Client devices 120 and 130 are configured to communicate with blockchain 110 and smart contract 111 via network 140 (e.g., communication via Transmission Control Protocol (TCP) and Internet Protocol (IP) to a computing device serving as a node of blockchain 110).

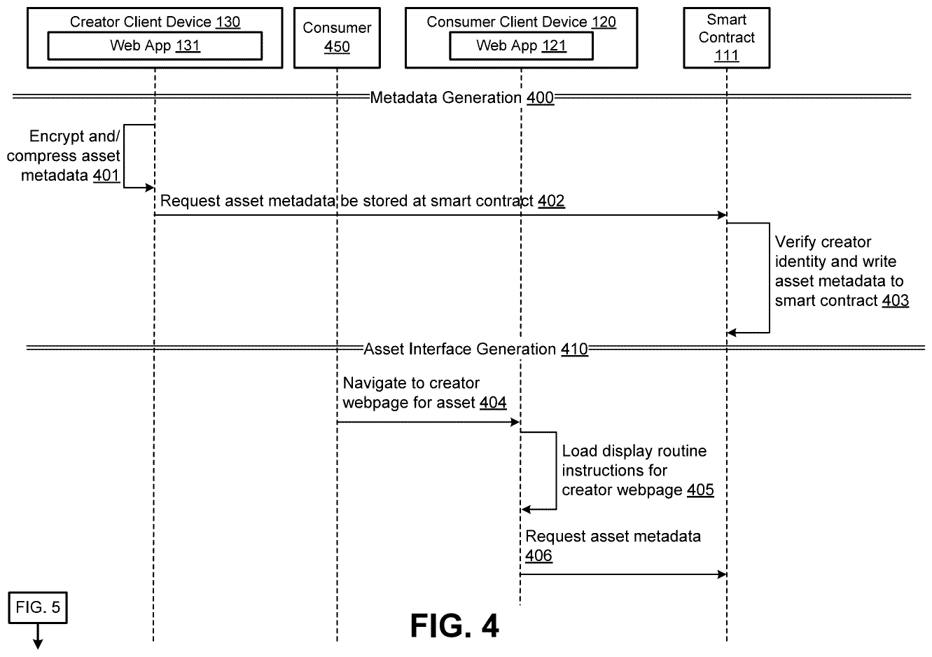

Web application 121 enables a creator to provide an interface for directly offering their asset. For example, a third-party retail platform is not involved in making the creator's asset available to the consumer for purchase. A depiction of this is exemplified in FIG. 3. Web application 121 enables creators to use a smart contract to both perform a transaction for an asset (e.g., a digital asset such as a non-fungible token (NFT)) and store metadata for rendering an interface for performing the transaction. By storing the data for rendering the interface within the smart contract, web application 121 eliminates the reliance on a third-party retail platform to provide an interface. Furthermore, this independence from the third-party enables decentralized commerce. Because third-party retail platforms are often centralized, blockchain transactions facilitated by these third-party platforms still rely on some centralized services. However, eliminating dependence from the centralized third-party retail platforms preserves the decentralized mission of blockchain.

Web application 121 operates on consumer client device 120. Specifically, web application 121 may operate within an Internet browser context executed on consumer client device 120. The browser context can execute when a user opens an Internet browser such as GOOGLE CHROME™ or MOZILLA FIREFOX®. Web application 121 may be executed when a consumer navigates to a website using an Internet browser. For example, web application 121 may be executed when the consumer navigates to a creator website, where the creator is offering an asset for purchase using physical currency (e.g., a fiat currency), digital currency, or both. To load web application 121 for access via the Internet browser, a creator or any suitable administrator of web application 121 may use a code package (e.g., JavaScript or typescript compatible module) that may be installed with a package manager (e.g., Node Package Manager (NPM)). The code package may include computer instructions executable by web application 121 for enabling decentralized transactions independent of third-party retail platform interfaces.

To retrieve metadata for displaying an interface for purchasing an asset, web application 121 determines data within which to query smart contract 111 to return the metadata associated with the asset. To query smart contract 111, web application 121 can use a call to a library that abstracts the blockchain, such as web3.js or ethers.js. Web application 121 may construct a call to the blockchain, which can include the address of smart contract 111. One example of pseudocode for querying the metadata is shown in Table 2 below.

TABLE 2
Example Implementation for Querying
Smart Contract for Metadata

```
var myContract = new web3.eth.Contract(parsed.abi);
const tx = {
  to: contractAddress,
  data: myContract.methods[“getRenderData”]( ).encodeABI( )
};
myContract.methods[method](params[0])
  .call().then(function(result){console.log(result)});
```

The data used to query the smart contract may include any suitable identifying data of the asset metadata. Example of data used to query smart contract 111 include a name of the asset, an identification number of the asset, an encoded or compressed representation thereof, or a combination thereof. For example, web 121 may determine a book's International Standard Book Number (ISBN) for querying the smart contract for metadata to generate an interface for purchasing the book. Web application 121 may be configured to retrieve asset identifying data from the webpage from which it is launched or the host of the webpage. Web application 121 may use an API or a webpage source code parser to receive the data from the webpage host or determine the data from the webpage source code (e.g., keyword or regular expression matching). Although interfaces for transactions are referenced here, the web application and functionality may apply to various interfaces for activities involving blockchain and smart contracts, where interface rendering metadata may be stored at the smart contract.

When requesting asset metadata, web application 121 may also include data for the smart contract to verify the authenticity of the request for the interface. Smart contract 111 may use a cryptographic key to verify one or more of the consumer's identity or creator's identity. The private key of the consumer may provide a cryptographic signature that web application 121 provides to smart contract 111 for authentication. Similarly, a private key of the creator may provide a cryptographic signature (e.g., retrieved from the creator via an application programming interface (API)). The smart contract may use a public key of the consumer or creator to verify a signature by a corresponding private key. Alternative or in addition to using a digital signature to verify the consumer's identity, smart contract 111 may use an address of the consumer's blockchain wallet provided by web application 121.

In some embodiments, smart contract 111 may maintain a list of identifiers of websites or entities associated with the websites that the creator has authorized to generate the user interface according to the metadata stored on smart contract 111. The identifiers may include digital signatures (e.g., addresses of blockchain wallets) of the entities. The list of identifiers may be created by the creator of the digital asset being offered through the smart contract-rendered interface. A user may navigate to a website that includes a graphical interface button to trigger the generation of the smart contract-rendered user interface. Before providing the metadata to the website for generation of the user interface, smart contract 111 compares the identifier provided by the website to the list of identifiers to determine whether the website is authorized. In response to determining that the website is authorized, smart contract 111 may proceed to provide the metadata to the website. In response to determining that the website is not authorized, smart contract 111 may withhold the metadata from the website. In this way, the creator may limit the websites that are able to offer the creator's asset (e.g., limit to websites that have entered into agreements with the creator to provide the asset for sale).

Web application 121 receives asset metadata retrieved by smart contract 111 using an asset identifier. Web application 121 converts the received metadata into a web element (e.g., a HyperText Markup Language (HTML) element). The retrieved metadata may include a string holding a web element. A first example of pseudocode to convert the retrieved metadata is shown in Table 3 below.

TABLE 3
First Example Implementation for Converting
Metadata into Web Element

document.getElementById(“productInfo”).innerHTML = result;

In Table 3, the variable “result” has a string that may hold HTML.

A second example of pseudocode to convert metadata into HTML that can be executed by web application 121 is shown in Table 4 below, where the result is a JSON object string.

TABLE 4
Second Example Implementation for Converting
Metadata into Web Element

```
Var resultJSON = JSON.parse(result);
html = ‘
  <h3>${resultJSON.title}</h3>
  <h2>${resultJSON.price}</h2>
  <p>${resultJSON.descrption}</p>’ ;
  document.getElementById(″productInfo″).innerHTML = resultJSON;
```

By converting the metadata into a web element, web application 121 can generate the web element. Web application 121 can insert the generated web element into a representation of the webpage (e.g., a document object model (DOM)). The inserted web element may thus serve as a holder for content displayed to the consumer for offering the asset. Web application 121 may render the web element hosted by the creator. In some embodiments, the webpage is the same webpage to which the consumer navigated to trigger web application 121 to query smart contract 111. In some embodiments, web application 121 renders the web element at a position on the webpage that overlays other web elements on the webpage. For example, web application 121 renders the generated web element with a larger z-index to cover web elements rendered with smaller z-indices.

Web application 121 may enable a flexible display of the generated web element. Thus, aligning with the spirit of a decentralized system, the interface rendered is flexible to be rendered anywhere that accessing the asset is relevant. Web application 121 may execute a forked implementation of instructions for rendering a webpage for offering the asset. For example, the instructions for rendering the interface for the asset may be forked such that instructions for rendering other web elements of the webpage are not dependent upon the execution of the forked instructions. In this way, a creator's main page HTML may be decoupled from the asset-specific HTML generated using smart contract 111, and the creator retains flexibility to generate components of their webpage that may not be related to offering the asset to the consumer. In some embodiments, the metadata can be stored as HTML or as JSON, where the HTML can be converted into an HTML element through an off-chain JavaScript library.

Web application 121 may reduce network bandwidth used by storing (e.g., caching) the metadata retrieved from smart contract 111. The network bandwidth of network 140 between a computing node of blockchain 110 (on which smart contract 111 may be hosted) and consumer client device 120 is used to transmit metadata for rendering the interface for offering the asset on consumer client device 120. By caching the metadata at the web browser of consumer client device 120, web application 121 reduces a number of requests for the metadata and transmission of the metadata, both of which occupy network bandwidth.

In some embodiments, web application 121 enables the consumer to opt in to use cryptocurrency for purchasing assets. For example, a consumer may store their blockchain wallet at the web browser on which web application 121 operates, but may not want web application 121 to access their blockchain wallet or check for its presence. Web application 121 may render a web element through which the consumer can opt in or out of using web application 121 for asset purchases. In response to determining that the consumer has opted out, web application 121 may determine not to render triggers for requesting rendering of smart contract-enables interfaces. In response to determining that the consumer has opted in, web application 121 may render unique code that can implement payment triggers.

Web application 121 may render a web element enabling the consumer to request the purchase of an asset offered by the creator. This web element may be referred to as a trigger. Web application 121 may render the trigger on the creator's web page. An example of a trigger is further described with reference to FIG. 3. The trigger may appear as a selectable button that, when selected, causes the execution of instructions for rendering the interface generated from metadata stored on smart contract 111. For example, the trigger may appear as a “see offers” button or a universal resource locator (URL) associated with text or an image identifying an offered asset. In response to determining a consumer has selected the trigger, web application 121 may query smart contract 111 to render an interface for offering the asset for purchase. In some embodiments, the asset may be offered at various different creators' websites, and each creator may leverage web application 121 to render interfaces for offering the asset. Web application 121 may use smart contract 111 to generate the same interface for the asset, agnostic of the creator, due to the rendering metadata at smart contract 111 returned to web application 121 for the same asset regardless of creator website. In this way, web application 121 may provide a consistent purchasing interface formatting across various creator webpages.

Web application 121 can determine whether to render the trigger on the creator's webpage. Web application 121 may determine that both the consumer and the creator meet criteria for fulfilling a transaction of the asset and in response, render the trigger. In response to determining at least one of the consumer or creator is unable to meet criteria for fulfilling the transactions, web application 121 may not render the trigger. Criteria for fulfilling the transaction may include the presence of payment means. For example, for a digital asset purchased via cryptocurrency, payment means may include a blockchain wallet of the consumer. Web application 121 may determine that the creator is offering a digital asset for purchase (e.g., receiving information of the asset or creator through an API). Web application 121 may determine whether the consumer has a blockchain wallet available for purchasing the digital asset. For example, web application 121 queries the web browser in which it operates for the presence of a stored blockchain wallet. In response to determining that a blockchain wallet is absent, web application 121 does not load the trigger for the consumer to request rendering of the interface for purchasing the asset.

In another example of determining whether to render the trigger, web application 121 may determine that both consumer and creator meet criteria for purchasing the asset using fiat currency (e.g., the dollar) through payment means such as credit card payment. Web application 121 may determine that a consumer, by default, may meet criteria for physical currency payment. Web application 121 may determine whether the creator accepts fiat currency payment in a similar manner with which web application 121 determines whether the creator accepts cryptocurrency payment. In response to determining that the creator accepts fiat currency payment, web application 121 may render the trigger for display at the consumer client device 120.

Web application 131 may be an instantiation of web application 121 on creator client device 130. That is, web application 121 and web application 131 may have the same functionality. A creator may use web application 131 to create or update metadata for storage at smart contract 111. Additionally, a creator can also use web application 131 to encrypt or compress the metadata to increase security and reduce storage resources expended at a computing node of blockchain 110, respectively.

Web application 131 may generate a user interface including input elements for a creator to specify metadata. For example, web application 131 may generate input fields for the creator to specify price of an asset offered. After receiving a user input specifying metadata values for storage, web application 131 may transmit a request to smart contract 111 to store the metadata. Web application 131 may include the user input and optionally, data for verifying the identity of the creator to smart contract 111 as a user who is authorized to write to smart contract 111. In some embodiments, data for verifying the identity may include a digital signature by the creator created using a cryptographic key. Smart contract 111 may use the creator's public key to verify the creator's identity. Data for verifying the identity of the creator may be retrieved automatically by smart contract 111. For example, as shown in Table 1, smart contract 111 may be instantiated with a variable having an identifier of the metadata author that is used for subsequent verification of the author's identity (e.g., the creator who authored the smart contract).

Web application 131 may encrypt the metadata specified by the creator before transmitting to a computing node of blockchain 110 for storage by smart contract 111. For example, web application 131 may use cryptographic keys to encode the metadata (e.g., using a symmetric cryptographic key). Web application 131 may compress the metadata prior to encryption. Web application 131 may compress metadata to conserve memory resources of blockchain computing nodes and reduce network bandwidth consumed when the string is sent to smart contract 111. For example, web application 131 may compress a string of metadata by any suitable lossless encoding algorithm (e.g., using minification). In some embodiments, a computing node on which blockchain 110 and smart contract 111 are executed may encrypt, decrypt, compress, and decompress metadata stored by smart contract 111. That is, alternative to web application 131 encrypting or compressing metadata and web application 121 decrypting or decompressing the compressed or encrypted metadata, the computing node is responsible and receives and sends unencrypted or uncompressed metadata.

In some embodiments, web application 121 may receive encrypted or compressed metadata from smart contract 111. For example, web application 131 or a computing node of blockchain 110 encrypts or compresses the metadata. Web application 121 may use an appropriate decryption mechanism (e.g., decrypting with a symmetric cryptographic key). Web application 121 can decompress the received metadata. For example, web application 121 can decompress using a decoding scheme corresponding to the lossless encoding scheme.

Network 140 may serve to communicatively couple blockchain 110, smart contract 111, consumer client device 120 and creator client device 130. Communication via network 140 may comprise any combination of local area and/or wide area networks, using wired and/or wireless communication systems. In some embodiments, network 140 uses standard communications technologies and/or protocols. For example, network 140 includes communication links using technologies such as Ethernet, IEEE 802.11, worldwide interoperability for microwave access (WiMAX), 3G, 4G, 5G, code division multiple access (CDMA), digital subscriber line (DSL), etc. Examples of networking protocols used for communicating via network 140 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over network 140 may be represented using any suitable format, such as hypertext markup language (HTML) or extensible markup language (XML). In some embodiments, all or some of the communication links of network 140 may be encrypted using any suitable technique or techniques.

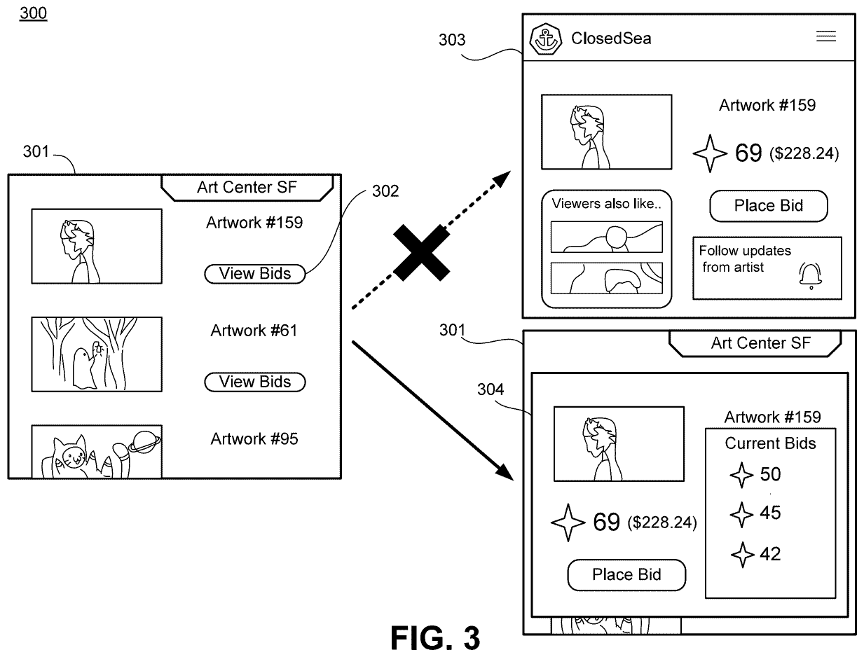

FIG. 2 depicts a block diagram of a process for rendering a webpage interface using a smart contract, according to one embodiment. Web application 121 is communicatively coupled to smart contract 211 (e.g., via a network like network 140). Web application 221 may have functionality of web apps 121 and 131. Web application 221 includes display rendering engine 222 and web representation 223. Display rendering engine 222 may be any suitable set of display routines executed by web application 221. For example, display rendering engine 222 can be a JavaScript engine that may execute instructions for rendering an interface for offering a creator's assets, as described with respect to web application 121. IN most embodiments, display rendering engine may will employ a web3 library to properly access data on the blockchain. Web representation 223 may represent a webpage through code configured to render a webpage on a browser on which web application 221 is executed. For example, web representation 223 is HTML for rendering a creator's website. Web representation 223 may include a reference to an instruction for display rendering engine 222. Smart contract 211 may have functionality of smart contract 111 and be hosted on a blockchain (i.e., by a computing node of the blockchain).

When a consumer navigates to a participating website (e.g., a creator's website) and the web browser retrieves a webpage onto which web application 221 is accessed, web application 221 can render a portion of the creator's webpage without the interface for offering the asset via webpage representation 223, which may be HTML injected into a DOM. Access to the webpage instructs 201 display rendering engine 222 to render the user interface for offering the asset. Display rendering engine 222 queries 202 smart contract 211 to retrieve the asset's metadata to render at web representation 222. Smart contract 211 returns 203 the metadata stored within smart contract 211. The metadata may describe what is rendered at the interface for offering the asset. Display rendering engine 222 converts the metadata to webpage markup (e.g., HTML) for insertion 204 at webpage representation 222. For example, the converted metadata is inserted 204 into the DOM as part of the webpage.

FIG. 3 illustrates a conceptual illustration 300 of smart contract-enabled interface generation that eliminates intervention by a third-party retail platform interface, in accordance with one embodiment. A consumer navigates to webpage 301. Webpage 301 is accessed via a web browser on which a web application for rendering asset purchasing interfaces (e.g., web application 121, 131, or 221) operates. The web application may determine that the consumer and the artist satisfy criteria for exchanging an asset (e.g., a physical art piece or an NFT of art) for cryptocurrency. For example, the web application determines the presence of a blockchain wallet by the consumer and the acceptance of cryptocurrency payment by the artist. The artist may provide feedback of which forms of payment the artist accepts via an interface generated by the web app. In response to determining the criteria are met, the web application may generate trigger 302 for generating interface 304 upon selection. The web application generates interface 304 as an overlay on webpage 301 using metadata retrieved from a smart contract used to facilitate the purchase transaction for the asset. Web application leverages the smart contract to store metadata for rendering interface 304, eliminating requirement of the host platform to render its own interface on its webpage 303. Thus, conceptual illustration 300 maintains the decentralized nature of a transaction on a blockchain by removing involvement of a centralized third-party retail platform. Furthermore, the storage of rendering metadata of interface 304 at a smart contract enables any entity to generate interface 304 at their website. In some embodiments, the smart contract may include rules indicating that only certain entities are authorized to access the rendering metadata and generate interface 304.

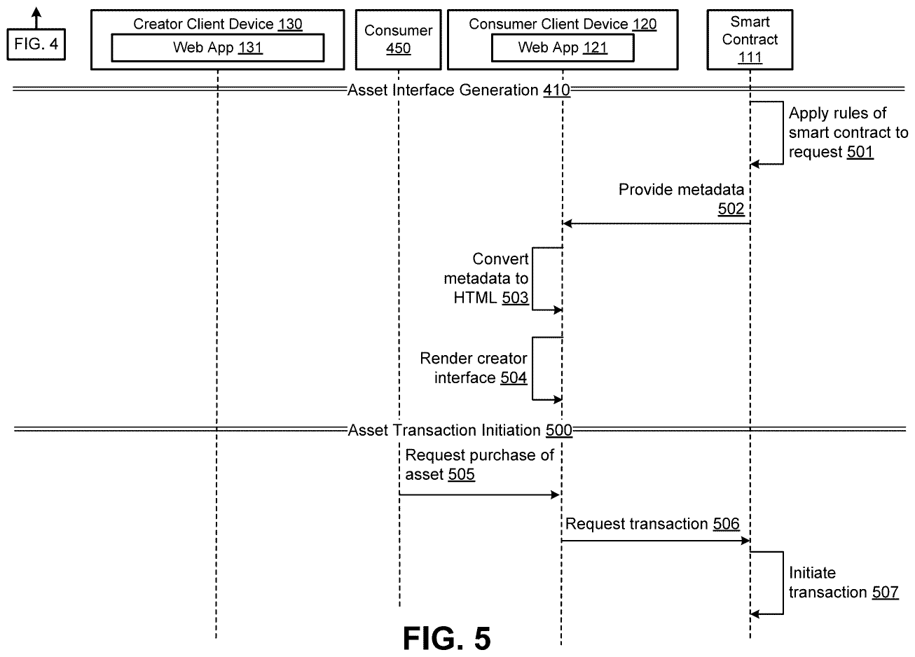

FIGS. 4-5 form an interaction diagram showing various interactions between entities for using a smart contract to render an interface, offer a transaction, and initiate the transaction, in accordance with one embodiment. The entities refer to entities introduced in FIG. 1. A creator uses creator client device 130 to store metadata on smart contract 111 for rendering an interface on a consumer's client device (e.g., consumer client device 120). Consumer 450 may then use consumer client device 120 to access the creator's webpage where the interface can be presented to initiate a transaction for the creator's asset absent a third-party retail platform. In some embodiments, the interactions illustrated in FIGS. 4-5 involve additional, fewer, or different functions or entities for performing the functions.

During metadata generation 400, creator client device 130 interacts with smart contract 111 to write metadata onto smart contract 111. In particular, web application 131 receives metadata specified by the user (e.g., an asset creator who is providing metadata for storage onto smart contract 111 to offer their asset for purchase) and may preprocess the metadata by encrypting and compressing 401 the metadata for rendering an interface for purchasing an asset, referred to as the asset's metadata. For example, web application 131 may receive, from the creator metadata including a value of a variable for the price of an asset (e.g., the value is an address at which the current price of an NFT may be retrieved). Web application 131 may compress and encrypt 401 the metadata. Web application 131 may then request 402 smart contract 111 to store the asset metadata. Although not depicted, smart contract 111 may be hosted on a computing node of a blockchain, and creator client device 130 may communicate with the computing node (e.g., via network 140). The request from web application 131 may also include data identifying client creator device 130 to smart contract 111 (e.g., an address of the creator's account on a blockchain or a digital signature of the creator using a cryptographic key). Smart contract 111 verifies the creator's identity and writes 403 the compressed and encrypted asset metadata into a data structure of smart contract 111 for subsequent access by web application 121.

During asset interface generation 410, consumer 450 uses web application 121 to retrieve metadata from smart contract 111 and initiate a transaction for the asset. Consumer 450 navigates 404 to a webpage (e.g., a commercial webpage) for the asset. In response, web application 121, which can be loaded onto a web browser of device 120 via an NPM, loads 405 display routines instructions for generating the creator-defined commercial interface for offering the asset. The display routine instructions may include JavaScript instructions for requesting 406 asset metadata and converting the metadata to a webpage element, as described in a subsequent interaction in FIG. 5. Further during asset interface generation 410, smart contract 111 applies 501 rules of the smart contract to the received request 406. For example, smart contract 111 includes a rule to return asset metadata in response to receiving an asset identifier. Smart contract provides 502 the asset metadata to web application 121, which converts 503 metadata to a web element (e.g., HTML inserted into the webpage DOM). Web application 121 renders 504 the creator interface using the converted HTML for display at the consumer client device 120. A “creator interface” may also be referred to herein as a “commercial interface.”

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

While particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for generating a user interface, the method comprising:
accessing webpage component rendering instructions including instructions for generating a commercial interface associated with a decentralized creator, an asset of the decentralized creator offered using the commercial interface;
in response to determining a user has requested to use the commercial interface, querying a smart contract for metadata associated with the asset, wherein the smart contract is queried in accordance with the instructions for generating the commercial interface;
generating a web element using the metadata; and
rendering for display at a device of the user the commercial interface using the generated web element.

2. The method of claim 1, further comprising:
determining whether the webpage instructions enable the user to request a cryptocurrency transaction; and
in response to determining that the webpage does not enable the user to request the cryptocurrency transaction, rendering the commercial interface with an option to use a fiat currency.

3. The method of claim 2, wherein determining whether the webpage instructions enable the user to request the cryptocurrency transaction comprises:
determining whether a cryptocurrency wallet is stored in a web browser associated with the user, wherein the presence of the cryptocurrency wallet corresponds to an ability to request the cryptocurrency transaction.

4. The method of claim 2, further comprising, rendering for display at the device of the user, a graphical user interface (GUI) input element configured to enable the user to opt in or opt out of performing transactions using a cryptocurrency.

5. The method of claim 1, wherein the metadata is compressed, and further comprising applying a decompression algorithm to the metadata.

6. The method of claim 1, wherein the metadata is encrypted, and further comprising applying a decryption algorithm to the metadata.

7. The method of claim 1, wherein the web element is an HTML document component.

8. The method of claim 1, further comprising inserting the HTML document component into a document object model (DOM) representing the webpage.

9. The method of claim 1, wherein the smart contract stores an identifier of the author of the metadata and the metadata.

10. The method of claim 1, further comprising providing a signature generated by a private key of the user to the smart contract, wherein the smart contract performs identity verification using the signature.

11. The method of claim 1, wherein the smart contract is modifiable to update the metadata of the asset.

12. A non-transitory computer-readable medium storing instructions for generating a user interface, the instructions when executed by at least one processor cause the at least one processor to:
access webpage component rendering instructions including instructions for generating a commercial interface associated with a decentralized creator, an asset of the decentralized creator offered using the commercial interface;
in response to determining a user has requested to use the commercial interface, query a smart contract for metadata associated with the asset, wherein the smart contract is queried in accordance with the instructions for generating the commercial interface;
generate a web element using the metadata; and
render for display at a device of the user the commercial interface using the generated web element.

13. A method for generating a user interface, the method comprising:
receiving, from a client device, a request for metadata associated with an asset of a decentralized creator;
applying a rule of a smart contract to the request, the smart contract storing the metadata associated with the asset, the rule mapping the stored metadata to an identifier of the asset; and
providing the metadata associated with the asset to the client device, the metadata used by a web application at the client device to generate a user interface for offering the asset.

14. (canceled)

15. The non-transitory computer-readable medium of claim 12, wherein the instructions when executed by the at least one processor further cause the at least one processor to:
determine whether the webpage instructions enable the user to request a cryptocurrency transaction; and
in response to determining that the webpage does not enable the user to request the cryptocurrency transaction, render the commercial interface with an option to use a fiat currency.

16. The non-transitory computer-readable medium of claim 15, wherein the instructions to determine whether the webpage instructions enable the user to request the cryptocurrency transaction comprises instructions that when executed by the at least one processor further cause the at least one processor to:
determine whether a cryptocurrency wallet is stored in a web browser associated with the user, wherein the presence of the cryptocurrency wallet corresponds to an ability to request the cryptocurrency transaction.

17. The non-transitory computer-readable medium of claim 12, wherein the metadata is compressed, and wherein the instructions when executed by the at least one processor further cause the at least one processor to apply a decompression algorithm to the metadata.

18. The non-transitory computer-readable medium of claim 12, wherein the metadata is encrypted, and wherein the instructions when executed by the at least one processor further cause the at least one processor to apply a decryption algorithm to the metadata.

19. The non-transitory computer-readable medium of claim 12, wherein the web element is an HTML document component.

20. The non-transitory computer-readable medium of claim 12, wherein the instructions when executed by the at least one processor further cause the at least one processor to insert the HTML document component into a document object model (DOM) representing the webpage.

21. The non-transitory computer-readable medium of claim 12, wherein the smart contract stores an identifier of the author of the metadata and the metadata.
